(19) United States
(12) Patent Application Publication
(10) Pub. No.: US 2012/0278697 A1
(43) Pub. Date: Nov. 1, 2012

(54) ELECTRONIC APPARATUS, METHOD OF CONTROLLING THE SAME AND PROGRAM

(76) Inventors: Sachie Yokoyama, Ome-shi (JP); Mieko Onodera, Kawasaki-shi (JP); Naoki Esaka, Tachikawa-shi (JP); Munehiro Tokikura, Kawasaki-shi (JP); Ayako Kanai, Ome-shi (JP)

(21) Appl. No.: 13/413,493

(22) Filed: Mar. 6, 2012

(30) Foreign Application Priority Data
Apr. 27, 2011 (JP) 2011-099749

(51) Int. Cl. G06F 3/14

(52) U.S. Cl. 715/234

(57) ABSTRACT

According to one embodiment, an apparatus includes a display including a first display screen, a reception module configured to receive first Web page data, a selection module configured to select a first region which is a part of a first Web page displayed on the first display screen based on the first Web page data, a display module configured to display the first region on the first display screen, and a transmission module configured to transmit first Web page display region data to a second electronic apparatus, the first Web page display region data including an address of the first Web page, position data showing a position of the first region in the first Web page, and a resolution of the first display screen.

### CROSS-REFERENCE TO RELATED APPLICATIONS

This application is based upon and claims the benefit of priority from prior Japanese Patent Application No. 2011-099749, filed Apr. 27, 2011, the entire contents of which are incorporated herein by reference.

### FIELD

Embodiments described herein relate generally to an electronic apparatus capable of displaying Web pages, a method of controlling the electronic apparatus, and a program.

### BACKGROUND

On the market are television receivers which can be connected to the Internet and can therefore display Web pages.

There is a demand that a specified region of any Web page be displayed, for example, in a magnified form, so that it may be better viewed that than otherwise.

It is not easy for the user to operate the TV remote controller in order to view the Web pages of the links presented in the Web page being displayed on his or her television receiver. This is why it is desirable to display a part of the image being on the television receiver and also on his or her personal computer monitor or smartphone.

There is another demand that any site that interests the user while he or she is viewing a Web page on the mobile personal computer or smartphone should be displayed on the large screen of the television receiver.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing various electronic apparatuses connected to a domestic LAN, one of which is an apparatus according to a first embodiment.

FIG. 2 is a diagram showing an exemplary Web page and a part designated in the exemplary Web page.

FIG. 3 is a diagram showing the parts of respective Web pages displayed by the electronic apparatus according to a first embodiment.

FIG. 4 is a block diagram showing an exemplary configuration of the electronic apparatus according to the first embodiment.

FIG. 5 is a diagram showing an exemplary webMag data generated in the electronic apparatus according to the first embodiment.

FIG. 6 is a diagram explaining the webMag data shown in FIG. 5.

FIG. 7 is a diagram showing an exemplary sequence of generating webMag data in the electronic apparatus according to the first embodiment.

FIG. 8 is a diagram explaining how the webMag data is transmitted.

FIG. 9 is another diagram explaining how the webMag data is transmitted.

FIG. 10 is a diagram showing the windows displayed on the display screen of a smartphone when a plurality of webMag data items are transmitted to the smartphone.

FIG. 11 is a diagram showing the data displayed on the display screen of the smartphone when one of the windows shown in FIG. 10 is selected.

FIG. 12 is a diagram showing an exemplary configuration of an electronic apparatus according to a second embodiment.

FIG. 13 is a diagram showing an exemplary sequence of generating webMag data in the electronic apparatus according to the second embodiment.

### DETAILED DESCRIPTION

Various embodiments will be described hereinafter with reference to the accompanying drawings.

In general, according to one embodiment, an electronic apparatus comprises a display, a reception module, a selection module, a display module, and a transmission module. The display comprises first display screen. The reception module is configured to receive first Web page data. The selection module is configured to select a first region which is a part of a first Web page displayed on the first display screen based on the first Web page data. The display module is configured to display the first region on the first display screen. The transmission module is configured to transmit first Web page display region data to a second electronic apparatus, the first Web page display region data comprising an address of the first Web page, position data showing a position of the first region in the first Web page, and a resolution of the first display screen.

### First Embodiment

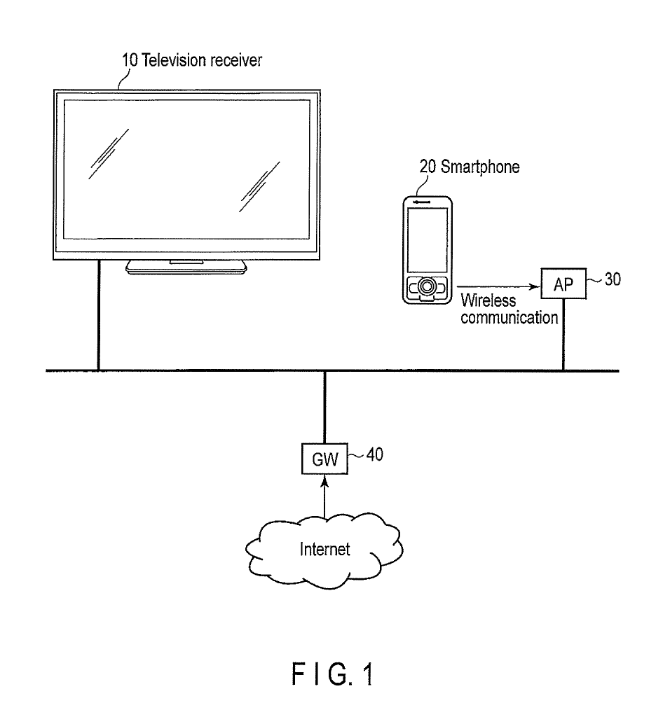

FIG. 1 is a diagram showing various electronic apparatuses connected to connected to a domestic LAN, one of which is an apparatus according to a first embodiment;

As shown in FIG. 1, a television receiver 10, a smartphone 20, an access point (AP) 30, and a gateway (GW) 40 are connected to a domestic LAN. The smartphone 20 can communicate with the television receiver 10 connected to the domestic LAN through the access point 30. The gateway connects the television receiver 10 and smartphone 20 to the Internet. If the access point 30 is not provided, the television receiver 10 and smartphone 20 may be connected directly to Bluetooth (registered trademark) or to the domestic LAN (DLAN).

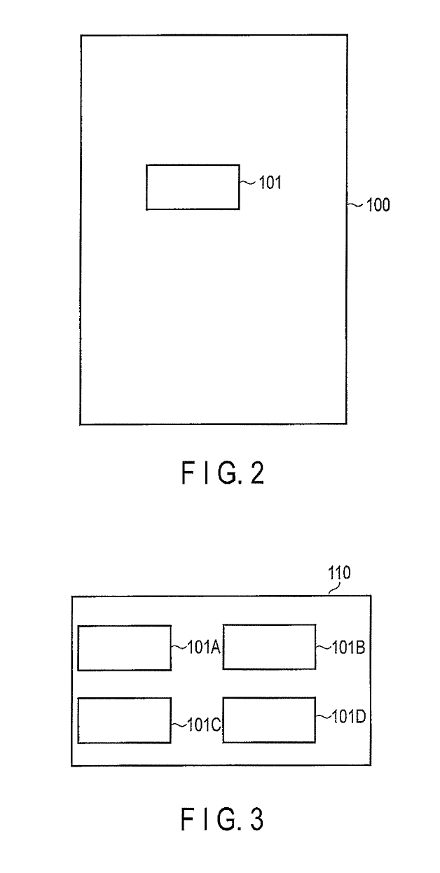

The television receiver 10 (i.e., electronic apparatus) can access any Web site on the Internet, to display a Web page on its screen. As shown in FIG. 2, the television receiver 10 can further display, on its screen 100, a part 101 of the Web page 100 the user has selected by operating a remote controller (not shown). Alternatively, as shown in FIG. 3, the television receiver 10 can display parts 101A to 101D of the Web page 100 on the screen 100.

The television receiver 10 transmits the data representing at least one of parts 101A to 101D of the Web page 100 displayed on the screen 100, to the smartphone 20. The parts being displayed on the screen 100 are therefore displayed also on the display screen of the smartphone 20.

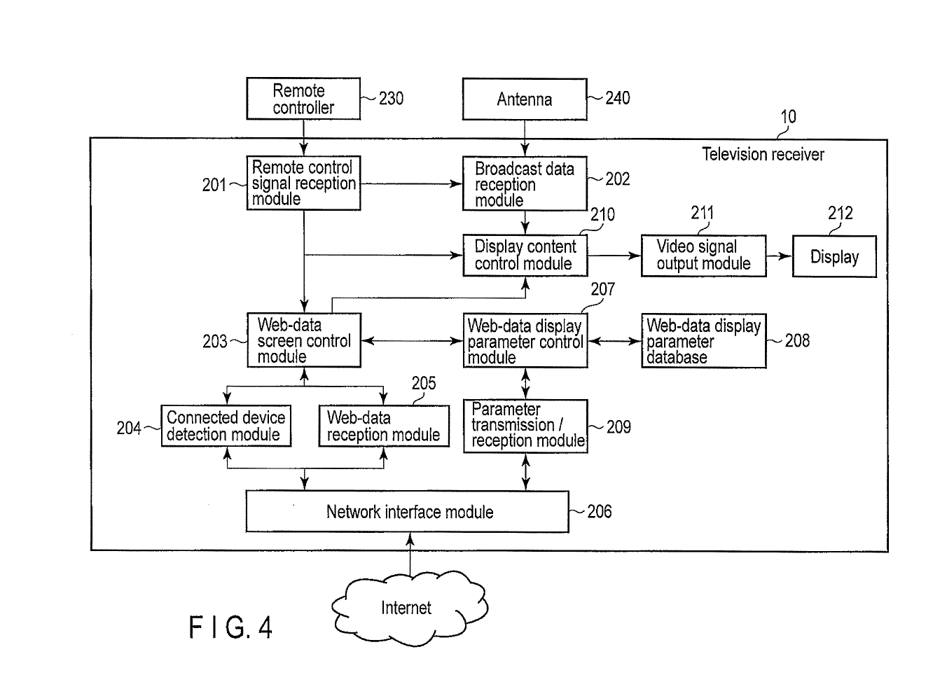

The configuration of the television receiver 10 will be described with reference to FIG. 4. FIG. 4 is a block diagram showing the configuration of the television receiver 10.

The television receiver 10 comprises a remote control signal reception module 201, a broadcast data reception module 202, a Web-data screen control module 203, a connected device detection module 204, a Web-data reception module 205, a network interface module 206, a Web-data display parameter control module 207, a Web-data display parameter database 208, a parameter transmission/reception module 209, a display content control module 210, a video signal output module 211, and a display 212.

The remote control signal reception module 201 receives an infrared-ray signal transmitted from a remote controller 230 to operate the television receiver 10, and supplies a signal corresponding to the infrared-ray signal received. The broadcast data reception module 202 generates program data from the broadcast signal received by an antenna 50. From the program data, video data and audio data are generated.

In accordance with the signal supplied from the remote control signal reception module 201, the display content control module 210 switches data, from the video data generated by the broadcast data reception module 202 to the video data generated by the Web-data screen control module 203, or vice versa, and outputs the video data to the video signal output module 211. The display 212 displays the image represented by the video signal from the video signal output module 211.

The Web-data screen control module 203 accesses a Web site in accordance with the signal supplied from the remote control signal reception module 201, and receives Web page data from the Web site through the network interface module 206.

The Web-data screen control module 203 generates video data from the Web page data so that the Web page may be displayed on the screen of the display 212. Further, in response to the signal supplied from the remote control signal reception module 201, the Web-data screen control module 203 generates video data so that the display 212 may display a selected region of the Web page displayed on the screen of the display 212.

The Web-data screen control module 203 receives webMag data and generates video data so that the display 212 may display a part of the Web site based on the webMag data. The webMag data is data that enables also any other device to display a magnified image of a specified region of the Web page, making it easy for the user to view the specified region of the Web page.

The Web-data display parameter control module 207 acquires the data about the selected part from the Web-data screen control module 203 and generates webMag data from the data so acquired. The webMag data generated is stored in the Web-data display parameter database 208.

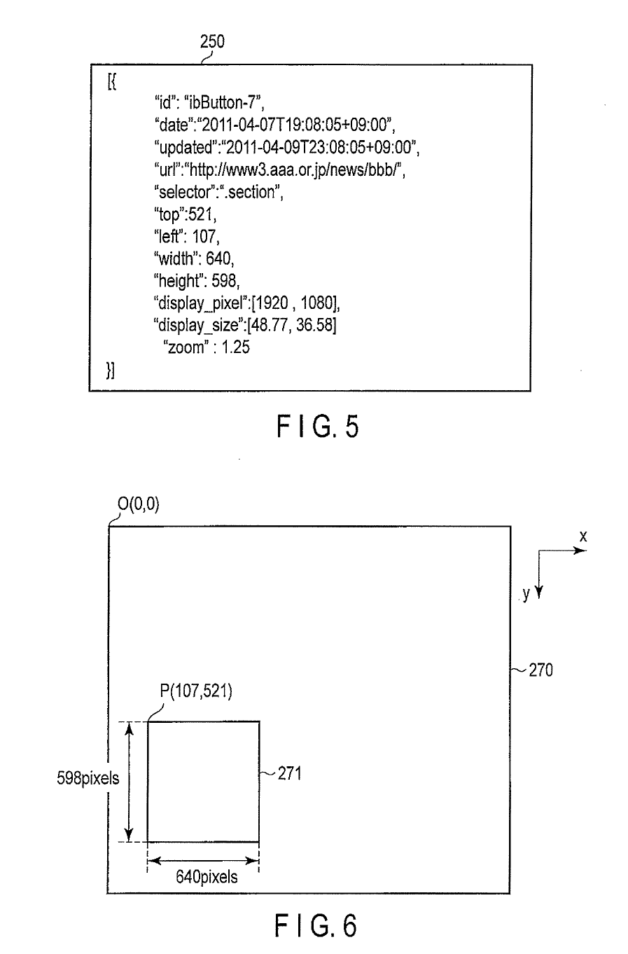

FIG. 5 shows an exemplary webMag data. In the webMag data shown in FIG. 5, “ibButton-7” following “id” is the ID number assigned to the webMag data. “2011-04007T19:08:05+09:00” for “date” is the time the webMag data has been generated. “2011-04-09T23:08:05+09:00” following “updated” is the time the display 212 has displayed the webMag data for the last time. “http://www3.aaa.or.jp/news/bbb/ following “url” is the URL of the Web page. “Selector” is the attribute (SCS data such as id or class) of the specified element (div or table) contained in HTML, i.e., “.section” to be extracted. 521 following “top” is the y-coordinate (pixels) of the start point where an element (region) 271 to be extracted is drawn in a Web page 270 as shown in FIG. 6. 107 following “left” is the x-coordinate (pixels) of the start point where the element 271 to be extracted is drawn in the Web page 270 as shown in FIG. 6. “640” following “width” is the width (pixels) of the element 271 to be extracted is drawn in the Web page 270 as shown in FIG. 6. 598 following “height” is the height (pixels) the element 271 to be extracted has in the Web page 270 as shown in FIG. 6. [1920. 1080] following “display pixel” is the resolution (pixels) the display 212 had when the webMag data was generated. [48.77, 36.58] following “display_size” is the size (cm) the display 212 has when the webMag data was generated. 1.25 following “zoom” is the magnification applied.

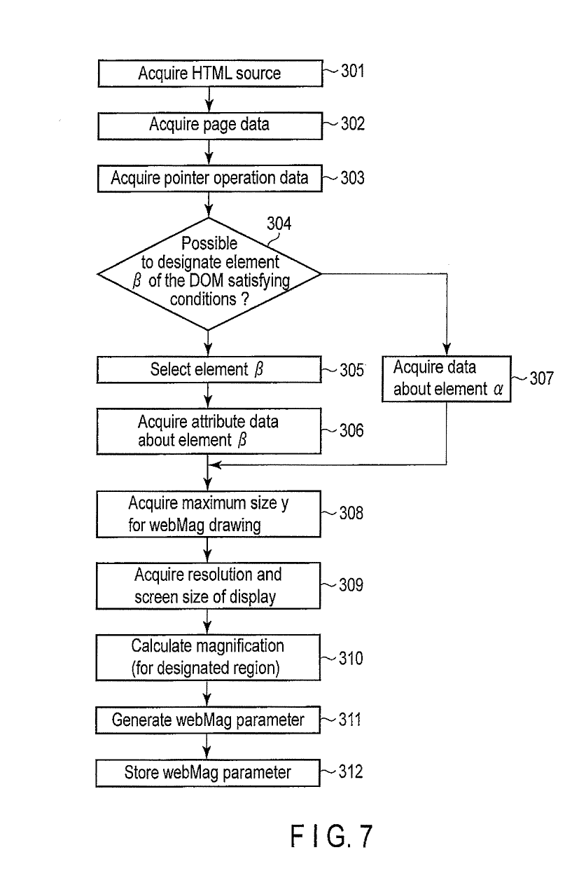

How the Web-data display parameter control module 207 generates the webMag data and stores the webMag data in the Web-data display parameter database 208 will be explained with reference to the flowchart of FIG. 7.

First, the Web-data display parameter control module 207 acquires the HTML source data of the Web page (Block 301). The Web-data display parameter control module 207 further acquires a URL and a document object model (DOM) from the source data (Block 302). In accordance with the pointer operation data input as the user operates the remote controller 230, the Web-data display parameter control module 207 acquires the start point, end point and area of the region a of the Web page, which has been set by the user who has operated the pointer on the remote controller 230 (Block 303). The Web-data display parameter control module 207 determines whether that element β of the DOM displayed in the selected region, which satisfies the following three conditions, can be uniquely designated or not (Block 304):

Element β has a larger area than region α.

(Area of element β)/(area of region α).

Region where element β overlaps region α is the largest.

If element β can be uniquely designated (Yes in Block 304), the Web-data display parameter control module 207 selects element β′ uniquely designated, as region selected by the user (Block 305). Then, the Web-data display parameter control module 207 acquires the attribute data about element β′ (Block 306). If element β cannot be uniquely designated (No in Block 304), the Web-data display parameter control module 207 acquires the data about the start point and end point of the region a (Block 307).

The Web-data display parameter control module 207 acquires the maximum size (width and height) in which a part of the Web page can be displayed (Block 308). Further, the Web-data display parameter control module 207 acquires the size of the display 212 (Block 309). The Web-data display parameter control module 207 acquires calculates a magnification (region/γ) (Block 310). Next, the Web-data display parameter control module 207 generates webMag data from the URL and the size (Block 311). The Web-data display parameter control module 207 stores the webMag data in the Web-data display parameter database 208.

If the remote controller instructs that the webMag data should be transmitted to the smartphone 20, the parameter transmission/reception module 209 transmits the webMag data to the smartphone 20.

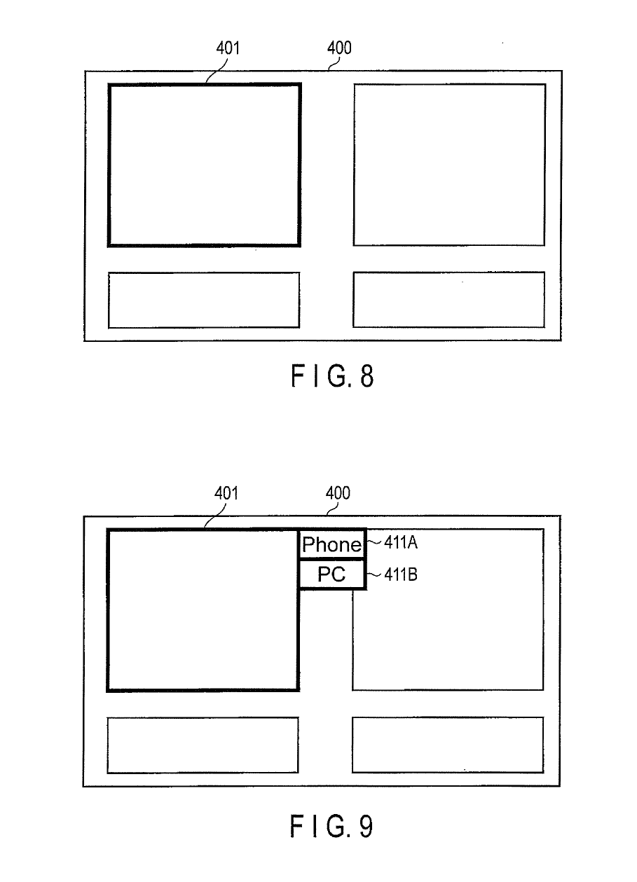

Assume that the user selects a window 404 designating a region of the Web page displayed on the display screen 400 as shown in FIG. 8, and that the user operates the OK key on the remote controller 230 as shown in FIG. 9. Then, buttons 411A and 411B are displayed on the display screen 400. If the user touches button 411A, designating the smartphone 20, the parameter transmission/reception module 209 transmits the webMag data to the smartphone 20.

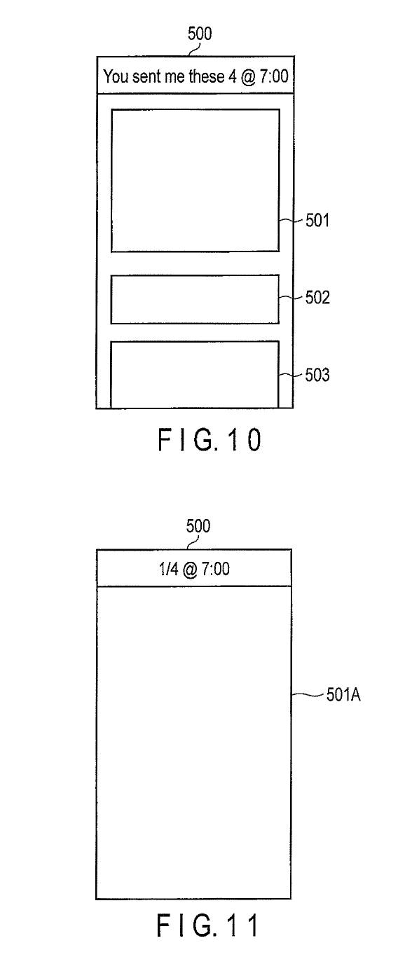

A plurality of webMag data items can be transmitted at a time to the smartphone 20. If several webMag data items are transmitted to the smartphone 20, windows 501, 502 and 503 will be displayed on the display screen 500 of the smartphone 20 as shown in FIG. 10. In the upper part of the display screen 500, “You sent me these 4 @ 7:00” is displayed, informing that four webMag data items were transmitted to the smartphone 20 at 7:00. The user may select, for example, the window 501. In this case, a window 501A including the Web page based on the URL described in the webMag data is displayed as shown in FIG. 11. At this point, “1/4 @ 7:00” is displayed in the upper part of the display screen 500, information that the Web page based on the URL described in the first of the four webMag data items transmitted at 7:00 is being displayed.

If the webMag data is transmitted from the television receiver 10 to the smartphone 20, a region of the Web page displayed in the display 212 of the television receiver 10 can be displayed in the display screen of the smartphone 20.

From the display size contained in the webMag data, the smartphone 20 determines the state of display of the Web page before the region was selected at the television receiver 10. On the basis of the Web page display state (i.e., start point, height and width) so determined, the region selected is extracted and displayed on the display of the smartphone 20.

### Second Embodiment

In this embodiment, webMag data is generated from a region of the Web page displayed on the smartphone 20 used in the first embodiment, and is transmitted from the smartphone 20.

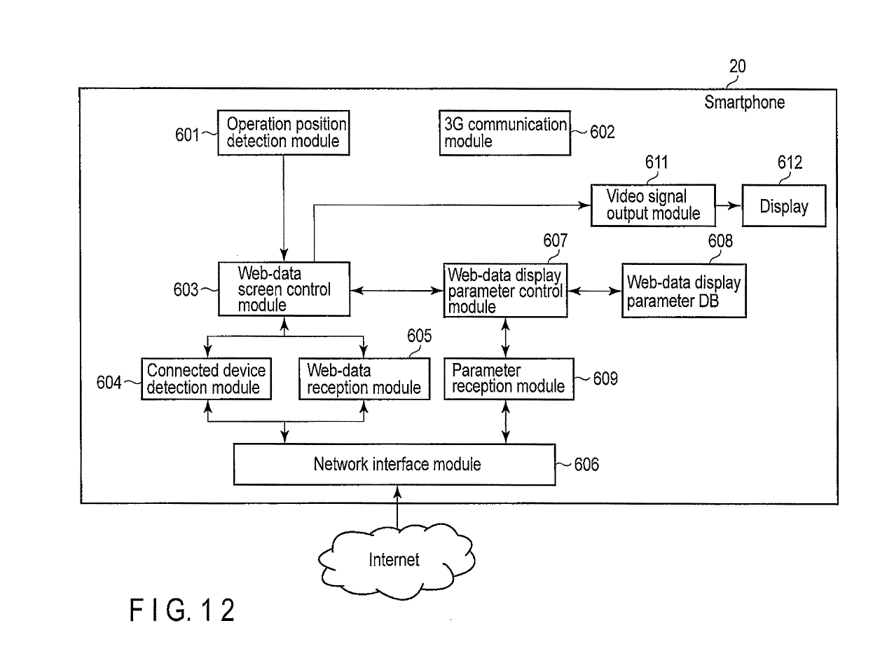

The configuration of the smartphone 20 will be described with reference to FIG. 12. FIG. 12 is a block diagram showing the configuration of the smartphone 20.

The smartphone 20 comprises an operation position detection module 601, a 3 G communication module 602, a Web-data display screen control module 603, a connected device detection module 604, a Web-data reception module 605, a network interface module 606, a Web-data display parameter control module 607, a Web-data display parameter database 608, a parameter reception module 609, a video signal output module 611, and a display 612.

The operation position detection module 601 detects the position where the user touched the display 612 and generates a signal representing the position detected. The 3 G communication module 602 is a communication module that accords with the International Mobile Telecommunication 2000 (IMT-2000) standards.

The Web-data display screen control module 603 accesses a Web site in accordance with the signal supplied from the operation position detection module 601, and then receives Web page data from the Web site through the network interface module 606. The network interface module 606 communicates, by radio, with the devices on a domestic LAN and with the Internet.

The Web-data screen control module 603 generates video data from the Web page data so that the Web page may be displayed on the screen of the display 612. Further, in response to the signal supplied from the remote control signal reception module 601, the Web-data screen control module 603 generates video data so that the display 612 may display a selected region of the Web page displayed on the screen of the display 612.

Upon receiving webMag data (described later) the Web-data screen control module 603 generates video data so that the display 612 may display a part of the Web site based on the webMag data.

The Web-data display parameter control module 607 acquires the data about a selected region from the Web-data screen control module 603 and generates webMag data from the data so acquired. The webMag data generated is stored in the Web-data display parameter database 608.

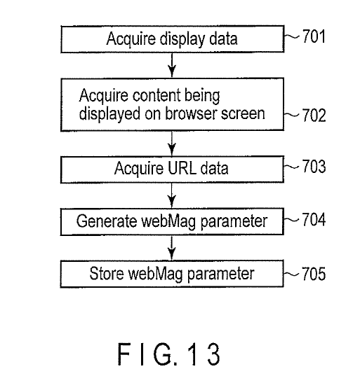

How the Web-data display parameter control module 607 generates the webMag data and stores the webMag data in the Web-data display parameter database 608 will be explained with reference to the flowchart of FIG. 13.

First, the Web-data display parameter control module 607 acquires the data about the display 612, i.e., resolution (width [pixels], height [pixels] and size (width [cm], height [cm]) (Block 701). The Web-data display parameter control module 607 then acquires the data about the Web site displayed on the browser (Block 702). The data about the Web site, displayed on the display 621, includes the data about a region a in the Web site displayed on the display 612 (i.e., start point, end point, height [pixels]) and the HTML source data. The Web-data display parameter control module 607 further acquires the URL of the Web site from the source data (Block 703). The Web-data display parameter control module 607 generates webMag data from the data about the display 612, the data about the region a (i.e., start point, end point, height [pixels]) and the URL of the Web site (Block 704). The webMag data thus generated is stored into the Web-data display parameter database 608.

The parameter transmission/reception module 609 transmits the webMag data stored in the Web-data display parameter database 608, to the television receiver 10.

Now that the webMag data has been transmitted from the smartphone 20 to the television receiver 10, a region of the Web page the display 612 of the smartphone 20 can be displayed on the display screen of the television receiver 10.

In the television receiver 10, the Web-data screen control module 203 determines the state of display of the Web page before the region was selected at the smartphone 20, from the display size and URL contained in the webMag data. The Web-data screen control module 203 extracts the region selected, from the state thus determined, in accordance with the position data (i.e., start point, height and width), and causes the display 212 to display the region extracted.

The television receiver 10 and the smartphone 20 have a processor, i.e., a computer that executes programs.

The process of displaying a position specified in a Web page, the process of generating webMag data and the process of displaying the specified position in accordance with the webMag data can be performed in this embodiment, by software. Hence, if the software, i.e., programs for performing these processes, is installed in an ordinary computer via a computer-readable storage medium containing the software, the same advantage as achieved in the embodiment will be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display comprising first display screen;
a reception module configured to receive first Web page data;
a selection module configured to select a first region which is a part of a first Web page displayed on the first display screen based on the first Web page data;
a display module configured to display the first region on the first display screen; and
a transmission module configured to transmit first Web page display region data to a second electronic apparatus, the first Web page display region data comprising an address of the first Web page, position data showing a position of the first region in the first Web page, and a resolution of the first display screen.

2. The apparatus of claim 1, further comprising receiving module configured to receive third Web page display region data transmitted from a third electronic apparatus configured to display a third region which is a part of a third Web page on a third display screen, the third Web page display region data comprising an address of the third Web page, position data showing a position of the third region in the third Web page, and a resolution of the third display screen,
wherein the display module is configured to display the third region on the first display screen based on the third Web page data.

3. The apparatus of claim 1, wherein the first region comprises an element described by a document object model.

4. The apparatus of claim 1, further comprising a second reception module configured to receive a broadcast signal and to generate video data and audio data according to program data included in the broadcast signal.

5. The apparatus of claim 1, further comprising a communication module configured to perform mobile communication.

6. A method of controlling an electronic apparatus, comprising:
receiving first Web page data;
selecting a first region which is a part of a first Web page displayed on a first display screen based on the first Web page data;
displaying the first region on the first display screen; and
transmitting first Web page display region data to a second electronic apparatus, the first Web page display region data comprising an address of the first Web page, position data showing a position of the first region in the first Web page, and resolution of the first display screen.

7. The method of claim 6, further comprising:
receiving third Web page display region data transmitted from a third electronic apparatus configured to display a third region which is a part of a third Web page on a third display screen, the third Web page display region data comprising an address of the third Web page, position data showing a position of the third region in the third Web page, and a resolution of the third display screen; and
displaying the third region on the first display screen based on the third Web page display region data.

8. The method of claim 6, wherein the first region comprises an element described by a document object model.

9. A computer-readable, non-transitory storage medium having stored thereon a computer program which is executable by a computer, the computer program controlling the computer to execute functions of:
receiving first Web page data;
selecting a first region which is a part of a first Web page displayed on a first display screen based on the first Web page data;
displaying the first region on the first display screen; and
transmitting first Web page display region data to a second electronic apparatus, the first Web page display region data comprising an address of the first Web page, position data showing a position of the first region in the first Web page, and resolution of the first display screen.

10. The medium of claim 9, wherein the computer program controls the computer to further execute functions of:
receiving third Web page display region data transmitted from a third electronic apparatus configured to display a third region which is a part of a third Web page on a third display screen, the third Web page display region data comprising an address of the third Web page, position data showing a position of the third region in the third Web page, and a resolution of the third display screen; and
displaying the third region on the first display screen based on the third Web page display region data.

11. The medium of claim 9, wherein the first region includes an element described by a document object model.
